(19) United States
(12) Patent Application Publication
(10) Pub. No.: US 2017/0004399 A1
(43) Pub. Date: Jan. 5, 2017

(54) LEARNING METHOD AND APPARATUS, AND RECORDING MEDIUM

(71) Applicant: Ryosuke KASAHARA, Kanagawa (JP)

(72) Inventor: Ryosuke KASAHARA, Kanagawa (JP)

(73) Assignee: Ricoh Company, Ltd., Tokyo (JP)

(21) Appl. No.: 15/187,961

(22) Filed: Jun. 21, 2016

(30) Foreign Application Priority Data
Jul. 1, 2015 (JP) 2015-132829

(51) Int. Cl. G06N 3/08

(52) U.S. Cl. CPC G06N 3/08

(57) ABSTRACT

A learning method for a multilayer neural network, implemented by a computer, includes starting first learning with an initial value of a learning rate, and maintaining the learning rate at the initial value or reducing the learning rate from the initial value as the first learning progresses. The learning rate is increased after the first learning. Second learning is started with the increased learning rate, and the increased learning rate is reduced as the second learning progresses.

### CROSS-REFERENCE TO RELATED APPLICATION

The present application claims priority under 35 U.S.C. §119 to Japanese Patent Application No. 2015-132829, filed on Jul. 1, 2015. The contents of which are incorporated herein by reference in their entirety.

### BACKGROUND OF THE INVENTION

1. Field of the Invention

The present invention relates generally to learning methods, learning apparatuses, and recording media in which a program for causing a computer to execute a process for learning is stored, and in particular, to a learning method and apparatus for artificial neural networks and a recording medium in which a program for causing a computer to execute a learning process for artificial neural networks is stored.

2. Description of the Related Art

In recent years, many studies have been made of methods for identifying an object, using machine learning. Deep learning, which is a branch of machine learning that uses a deep artificial neural network, enjoys high identification performance.

As such machine learning using an artificial neural network (hereinafter “neural network”), for example, Japanese Patent No. 3323894 describes machine learning aiming at increasing the learning speed of neural networks. Specifically, Japanese Patent No. 3323894 describes a learning method for a multilayer neural network using the conjugate gradient method, where the learning method includes providing an initial value of the weight of a neuron, determining the steepest descent gradient of an error relative to the weight of the neuron, calculating the proportion of the previous conjugate direction to be added to the steepest descent direction, determining the next conjugate direction from the steepest descent gradient and the previous conjugate direction, determining a local minimum error point to the extent that the difference between the layer average of neuron weight norms at the search start point of a line search and the layer average of the norms of neuron weight norms at a search point does not exceed a certain value, and update the weight in correspondence to the minimum error point thus determined.

Furthermore, for example, Japanese Unexamined Patent Application Publication No. 4-262453 describes a method for avoiding the protraction of learning to increase the speed of learning in neural networks, where the method includes notifying a user of the protraction of learning and presenting the user with options for avoiding the protraction of learning when the protraction of learning takes place.

For the related art, further reference may be made to, for example, Le Cun, Y., B. Boser, J. S. Denker, D. Henderson, R. E. Howard, W. Hubbard, and L. D. Jackel; “Handwritten Digit Recognition with a Back-Propagation Network,” Advances in Neural Information Processing Systems (NIPS), 1990, pp. 396-404, and He, K., X. Zhang, S. Ren, and J. Sun; “Delving Deep into Rectifiers: Surpassing Human-Level Performance on ImageNet Classification,” arXiv preprint arXiv:1502.01852v1 (2015) (“He et al.”).

### SUMMARY

According to an aspect of the present invention, a learning method for a multilayer neural network, implemented by a computer, includes starting first learning with an initial value of a learning rate, and maintaining the learning rate at the initial value or reducing the learning rate from the initial value as the first learning progresses. The learning rate is increased after the first learning. Second learning is started with the increased learning rate, and the increased learning rate is reduced as the second learning progresses.

### BRIEF DESCRIPTION OF THE DRAWINGS

FIG. 1 is a diagram depicting a learning apparatus for neural networks according to an embodiment;

FIG. 2 is a diagram illustrating neural network learning;

FIG. 3 is a diagram depicting a multilayer neural network;

FIG. 4 is a diagram depicting an autoencoder;

FIG. 5 is a diagram depicting a stacked autoencoder;

FIGS. 6A through 6C are diagrams illustrating a learning method of the stacked autoencoder;

FIG. 7 is a diagram depicting a neural network for illustrating backpropagation;

FIG. 8 is a flowchart of a typical learning method for multilayer neural networks known to the inventor;

FIG. 9 is a flowchart of a learning method for multilayer neural networks according to the embodiment; and

FIG. 10 is a graph illustrating a relationship between the number of times of updating and a loss value.

### DESCRIPTION OF THE EMBODIMENTS

There is a demand for a learning method that completes learning for deep neural networks in a short time.

According to an, aspect of the present invention, a learning method capable of completing learning for deep neural networks in a short time is provided.

One or more embodiments are described below. In the following description, the same elements or members are referred to using the same reference numeral, and are not repetitively described.

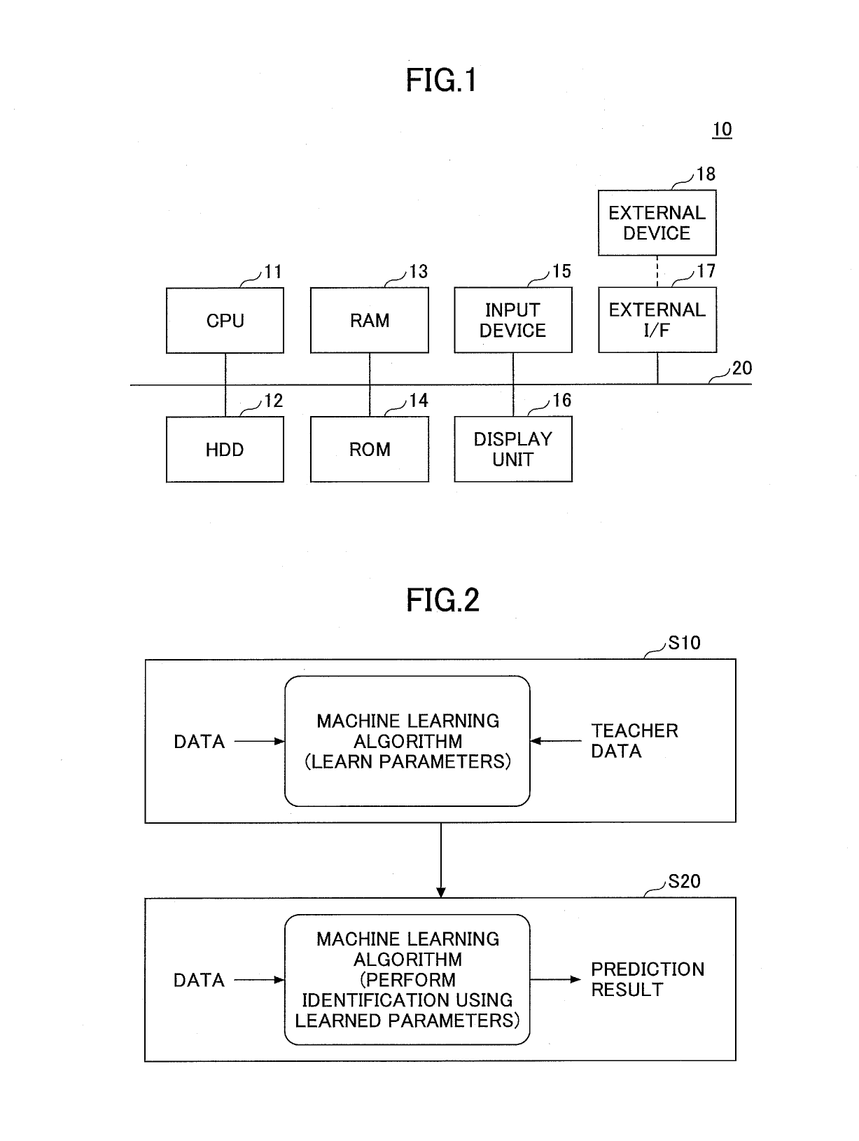

FIG. 1 is a diagram depicting a hardware configuration of an information processing apparatus 10 serving as a learning apparatus for neural networks (hereinafter “learning apparatus”) according to an embodiment. A common processing system such as a personal computer (PC) may be used for the information processing apparatus 10.

Referring to FIG. 1, the information processing apparatus 10 includes a central processing unit (CPU) 11, a hard disk drive (HDD) 12, a random access memory (RAM) 13, a read-only memory (ROM) 14, an inputting device 15, a displaying unit 16, and an external interface (I/F) 17, all of which are interconnected by a bus 20.

The CPU 11 is a processor that reads programs and data from storage devices such as the ROM 14 and the HDD 12 into the RAM 13 and executes processing to perform overall control and functions of the information processing apparatus 10. The CPU 11 serves as an information processing control unit of the learning apparatus of this embodiment to execute a learning method for neural networks (hereinafter “learning method”) according to this embodiment.

The HDD 12 is a nonvolatile storage device that contains programs and data. The contained programs and data include, for example, a program for implementing this embodiment, an operating system (OS), which is basic software for performing overall control of the information processing apparatus 10, and application software that presents various functions on the OS. The HDD 12 manages the contained programs and data with at least one of a predetermined file system and a database (DB). The information processing apparatus 10 may include an additional storage device such as a solid state drive (SSD) in place of or together with the HDD 12.

The RAM 13 is a volatile semiconductor memory (storage device) that temporarily retains programs and data. The ROM 14 is a nonvolatile semiconductor memory (storage device) capable of retaining programs and data even after power is turned off.

The inputting device 15 is used for a user to input various operation signals. The inputting device 15 includes, for example, various operation buttons, a touchscreen, a keyboard, and a mouse.

The displaying unit 16 displays the results of processing by the information processing apparatus 10. The displaying unit 16 includes, for example, a display.

The external I/F 17 is an interface with an external device 18. Examples of the external device 18 include a universal serial bus (USB) memory, a Secure Digital (SD) card, a compact disk (CD), and a digital versatile disk (DVD).

The information processing apparatus 10 according to this embodiment has the above-described hardware structure to be able to implement the various processes described below.

Next, a machine learning algorithm using the learning apparatus of this embodiment is described with reference to FIG. 2. Specifically, as depicted in FIG. 2, at step S10, at the time of learning, input data and corresponding teacher data that are a correct answer to the input data are input to the machine learning algorithm, and the machine learning algorithm is executed to optimize and learn the algorithm parameters. Next, at step S20, at the time of prediction, the machine learning algorithm is executed to identify input data and output a prediction result, using the learned parameters. Of the above-described learning procedure and prediction procedure of the machine learning algorithm, this embodiment relates to the learning procedure of the machine learning algorithm, and particularly illustrates the parameter optimization of a multilayer neural network in the learning procedure of the machine learning algorithm.

As described below, the learning method according to this embodiment increases learning rate during learning. For convenience of description, first, an outline of learning methods for neural networks is given, and thereafter, the learning method according to this embodiment is described in detail. According to this embodiment, backpropagation is employed for learning, that is, parameter optimization.

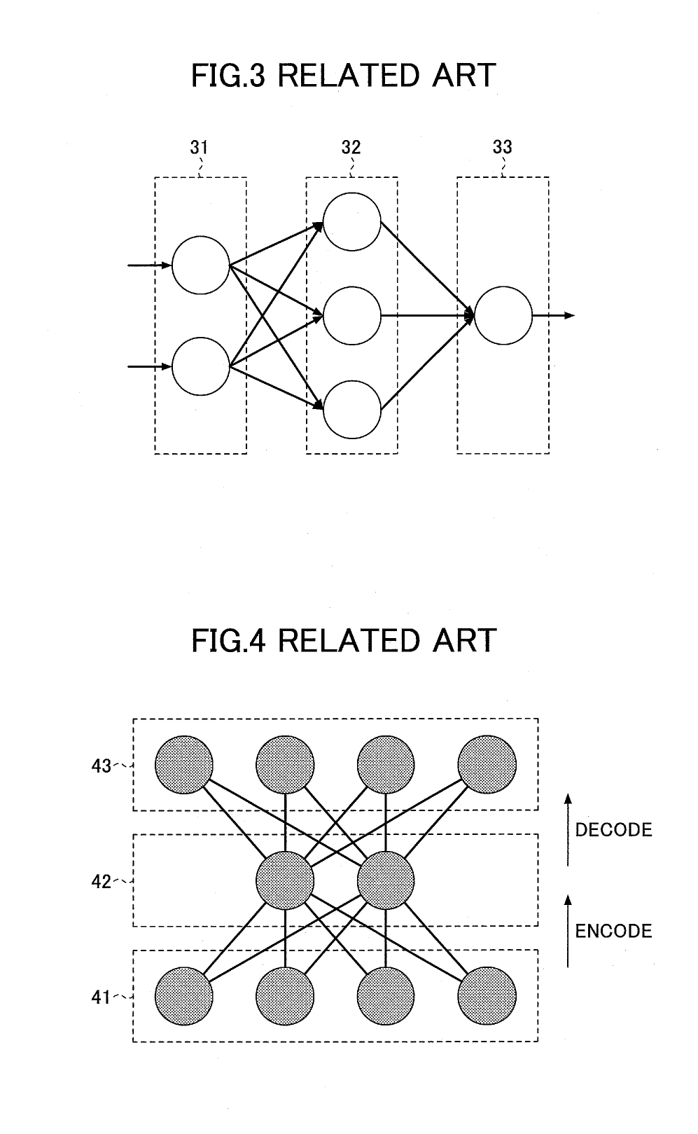

First, multilayer neural networks are described. The neural network is a mathematical model aiming at simulating some characteristics of brain functions on a computer. The multilayer neural network (also referred to as “multilayer perceptron”), which is a kind of neural network, is a feedforward neural network with neurons disposed in multiple layers. By way of example, FIG. 3 depicts a multilayer neural network where neurons, indicated by circles, are connected in multiple layers, namely, an input layer 31, a middle or hidden layer 32, and an output layer 33.

One of the techniques for dimensionality reduction (also referred to as “dimensionality compression”) in such a neural network is an architecture referred to as “autoencoder”. FIG. 4 depicts an autoencoder that has an input layer 41, a middle layer 42, and an output layer 43. The autoencoder is trained to equalize the number of outputs to the number of inputs of a teacher signal as depicted in FIG. 4. By thus making the number of neurons of the middle layer 42 smaller than the number of dimensions of the input, it is possible to perform dimensionality reduction to reproduce input data with a fewer dimensions.

It is known that by configuring a neural network with multiple layers, the representation ability of the neural network increases to improve the performance of a classifier and it is possible to perform dimensionality reduction. Therefore, in the case of performing dimensionality reduction, it is possible to improve the performance of a dimension reducer by reducing the number of dimensions to a desired value not through a single layer but through multiple layers. One example of this architecture is a stacked autoencoder in which autoencoders are stacked to constitute a dimension reducer. It is possible to improve the performance of the dimension reducer by individually training each layer and thereafter performing training referred to as “fine-tuning (or fine-training)” on the combination of the layers as a whole. It is possible to desirably reduce dimensions, using the stacked autoencoder in which autoencoders trained layer by layer are combined into multiple layers.

According to the stacked autoencoder, layer-by-layer training is required, and it is often the case that fine-tuning is performed to train a deep neural network. Accordingly, training (learning) is extremely time-consuming. By applying this embodiment, however, it is possible to complete training (learning) in a short time. Furthermore, by applying this embodiment, neural networks deeper than typical neural networks known to the inventor are trained with no time problem. As a result, it is possible to improve the accuracy of identification.

Next, the stacked autoencoder, which is a kind of multilayer neural network, is described. In this case, the training of a dimension reducing part and a dimension reconstructing part in the stacked autoencoder corresponds to adjusting the network coefficients (also referred to as “weights”) of each layer of the stacked autoencoder based on input training data. Such network coefficients are examples of predetermined parameters.

The stacked autoencoder is a neural network in which neural networks referred to as autoencoders are stacked into layers. The autoencoder is a neural network in which the input layer and the output layer have the same number of neurons (the same number of units) and the middle layer (hidden layer) has less neurons (units) than the input layer (output layer).

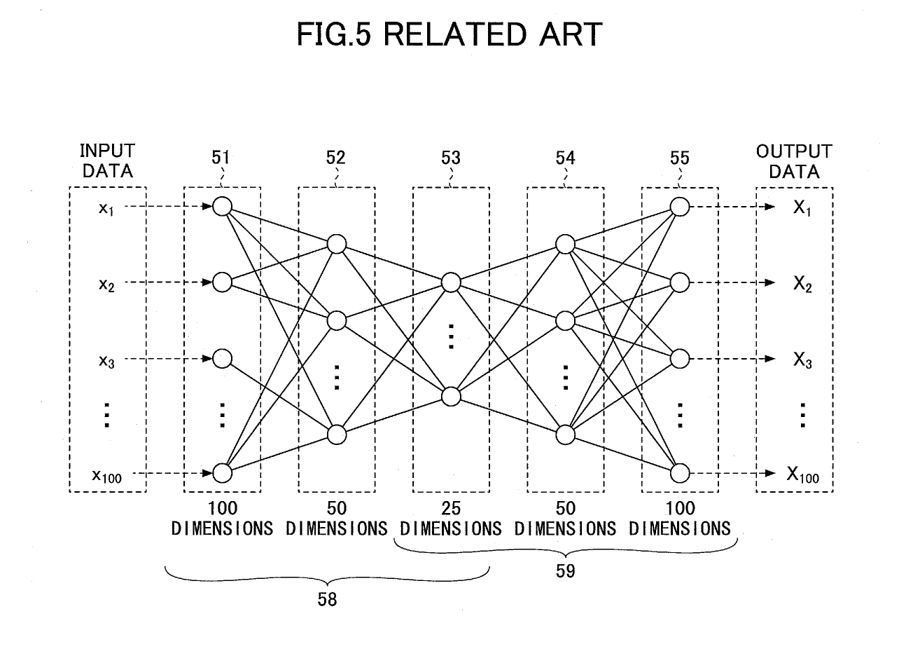

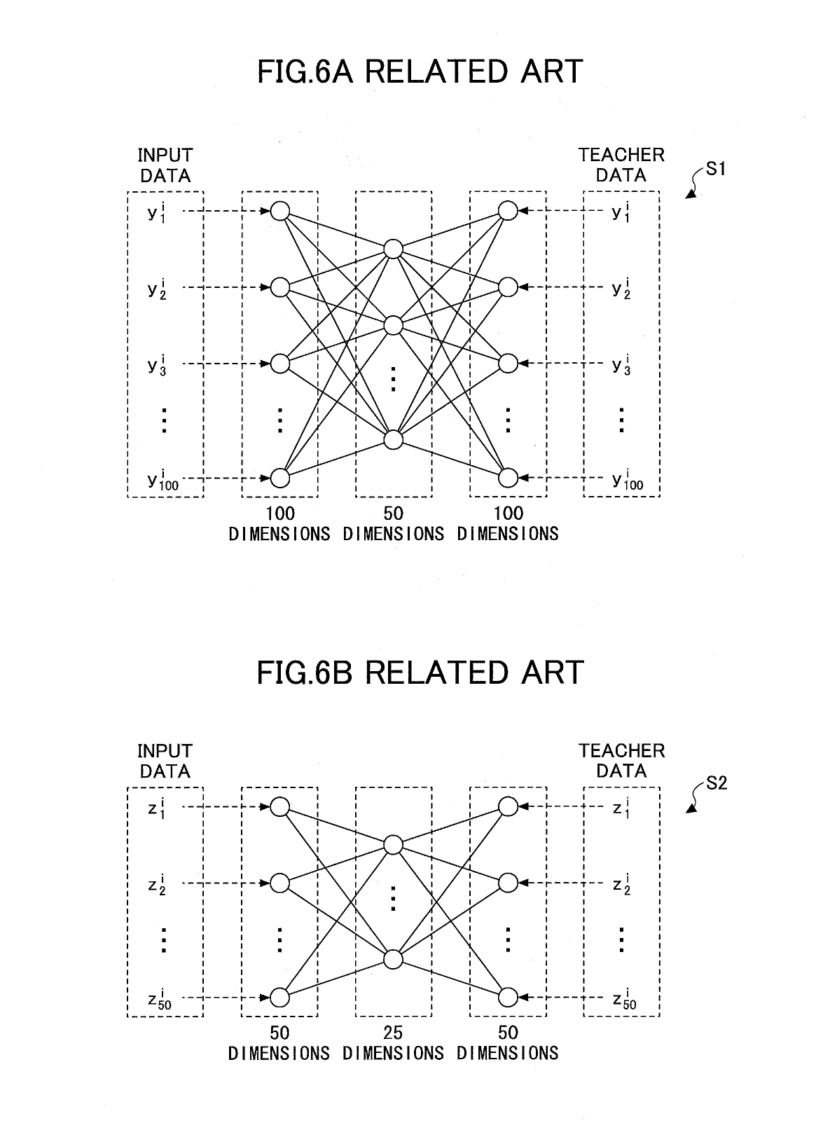

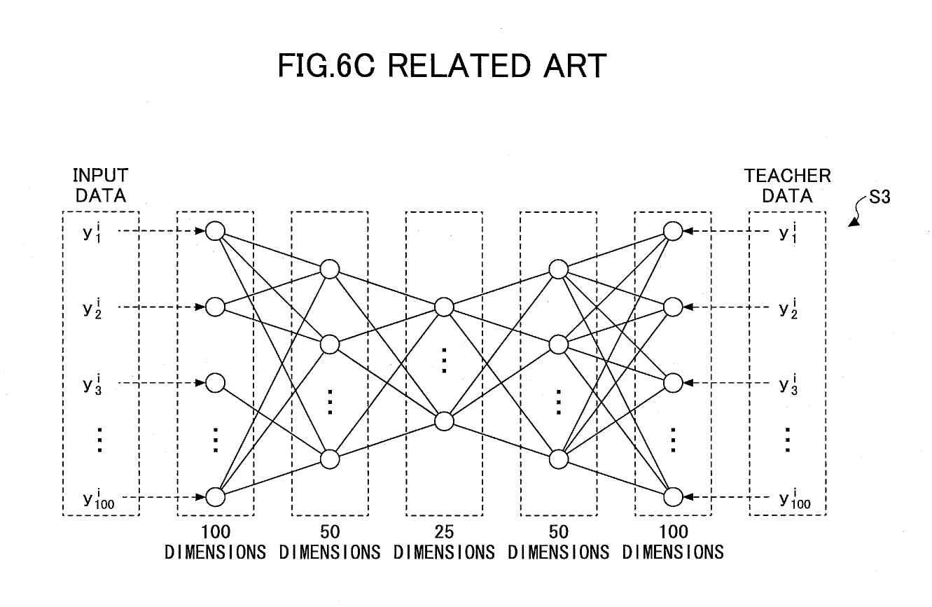

By way of example, a stacked autoencoder in which a dimension reducing part 58 and a dimension reconstructing part 59 are formed of five layers 51, 52, 53, 54, and 55 as depicted in FIG. 5 is described. That is, the dimension reducing part 58 reduces the number of dimensions of input vector data of 100 dimensions to 50, and thereafter, reduces the number of dimensions of the vector data of 50 dimensions to 25. The dimension reconstructing part 59 reconstructs the input vector data of 25 dimensions to vector data of 50 dimensions, and thereafter, reconstructs the vector data of 50 dimensions to vector data of 100 dimensions. The training of the stacked autoencoder depicted in FIG. 5 is described with reference to FIGS. 6A through 6C.

The training of the stacked autoencoder is performed with respect to each of the autoencoders constituting the stacked autoencoder. Accordingly, the stacked autoencoder depicted in FIG. 5 is trained with respect to a first autoencoder and a second autoencoder that constitute the stacked autoencoder (FIGS. 6A and 6B). Finally, training referred to as “fine-tuning” is performed (FIG. 6C).

At step S1 depicted in FIG. 6A, the first autoencoder is trained using 1000 sets of training data. That is, the first autoencoder, which includes a first layer (input layer) having 100 neurons, a second layer (middle or hidden layer) having 50 neurons, and a third layer (output layer) having 100 neurons, is trained using training data.

Such training may be performed using backpropagation, using yⁱ (i=1 through 30) as input data and teacher data for the first autoencoder, with respect to each input i. That is, network coefficients are so adjusted by backpropagation using training data as to make the input data and the output data of the first autoencoder equal.

Next, at step S2 depicted in FIG. 6B, the second autoencoder is trained, using the data input to the second layer of the first autoencoder as input data.

Here, in the first autoencoder, the network coefficients of the jth neuron (j=1 through 50) in the second layer with respect to the neurons of the input layer (first layer) are defined as w_{1,j} through w_{100, j}. In this case, the input data of the second autoencoder are expressed by Eq. (1):

$${z}^{i} = ( {z}_{1}^{i} , {z}_{2}^{i} , … , {z}_{50}^{i} ) = ( {\sum }_{k = 1}^{100} {w}_{k , 1} {y}_{k}^{i} , {\sum }_{k = 1}^{100} {w}_{k , 2} {y}_{k}^{i} , … , {\sum }_{k = 1}^{100} {w}_{k , 20} {y}_{k}^{i} ) \qquad ( 1 )$$

Accordingly, the second autoencoder may be trained using backpropagation, using zⁱ (i=1 through 30) as input data and teacher data for the second autoencoder, with respect to each input i. That is, network coefficients are so adjusted by backpropagation using 30 vector data zⁱ of 50 dimensions as to make the input data zⁱ and the output data of the second autoencoder equal.

At step S3 depicted in FIG. 6C, after each autoencoder of the stacked autoencoder is trained, training referred to as “fine-tuning” is performed. Fine-turning is to train, using training data, a stacked autoencoder whose autoencoders have been trained. That is, the stacked autoencoder may be trained using backpropagation, using yⁱ as input data and teacher data for the stacked autoencoder, with respect to each input i. That is, network coefficients are so adjusted by backpropagation using training data as to make the input data and the output data of the stacked autoencoder equal.

Such fine-tuning is performed at the end to finely adjust the network coefficients of the stacked autoencoder, so that it is possible to improve the performance of the dimension reducing part 58 and the dimension reconstructing part 59.

The stacked autoencoder may be, but is not limited to, the above-described example having five layers of 100, 50, 25, 50, and 100 neurons. The number of neurons of each layer of the stacked autoencoder and the number of layers constituting the neural network of the stacked autoencoder are design matter, and may be set to desired values.

It is preferable, however, that dimensionality reduction by the dimension reducing part 58 and dimensionality reconstruction by the dimension reconstructing part 59 be performed through multiple layers. For example, it is assumed that vector data of 100 dimensions are reduced to vector data of 25 dimensions as described above. In this case, successively reducing the number of dimensions through multiple layers as described above (five layers in the above-described case) is preferable to reducing the number of layers using a stacked autoencoder having three layers of 100, 25, and 100 neurons.

The convolutional neural network (CNN) is a technique often employed in deep neural networks for image and video recognition. Standard backpropagation is used for learning. The CNN has the following two basic structural features.

The first feature is convolution. Convolution does not connect all neurons between layers, but connects neurons that are positionally close on an image. Furthermore, the coefficients of the CNN do not depend on a position on the image. Qualitatively, feature extraction is performed by convolution. Furthermore, connections are limited to prevent overtraining.

The second feature is pooling. Pooling reduces positional information when connecting to the next layer. Qualitatively, position invariance is obtained. Pooling includes max pooling that outputs a maximum value and average pooling that outputs an average.

It is often the case with the CNN that a large amount of image data is input for training, so that training (learning) is extremely time-consuming. By applying this embodiment, however, it is possible to complete training (learning) in a short time. Furthermore, by applying this embodiment, neural networks deeper than typical neural networks known to the inventor are trained with no time problem. As a result, it is possible to improve the accuracy of identification.

The recurrent neural network (RNN) is a neural network architecture in which the output of a hidden layer is used as an input at the next time. According to the RNN, an output is returned as an input. Accordingly, an increase in learning rate causes easy divergence of coefficients. Therefore, it is desired to take time in training (learning) with a reduced learning rate. By applying this embodiment, however, it is possible to complete training (learning) in a short time. Furthermore, by applying this embodiment, neural networks deeper than typical neural networks known to the inventor are trained with no time problem. As a result, it is possible to improve the accuracy of identification.

Backpropagation is used to train neural networks. An outline of backpropagation is given below. According to backpropagation, the output of a network is compared with teacher data, and the error of each output neuron is calculated based on a comparison result. Based on the assumption that the error of an output neuron is attributable to the neurons of the preceding layer (“first preceding layer”) connected to the output neuron, weight parameters on the connections from the preceding neurons to the output neuron are updated to reduce the error. Furthermore, with respect to each preceding neuron, the error between an actual output and an expected output is calculated. This error is referred to as a local error. Based on the assumption that the local error is attributable to the neurons of the preceding layer (second preceding layer) that precedes the first preceding layer, connected to the preceding neurons, weight parameters on the connections from the neurons of the second preceding layer to the preceding neurons are updated. Preceding neurons are thus traced back and updated one after another, so that weights on the connections of all neurons are finally updated.

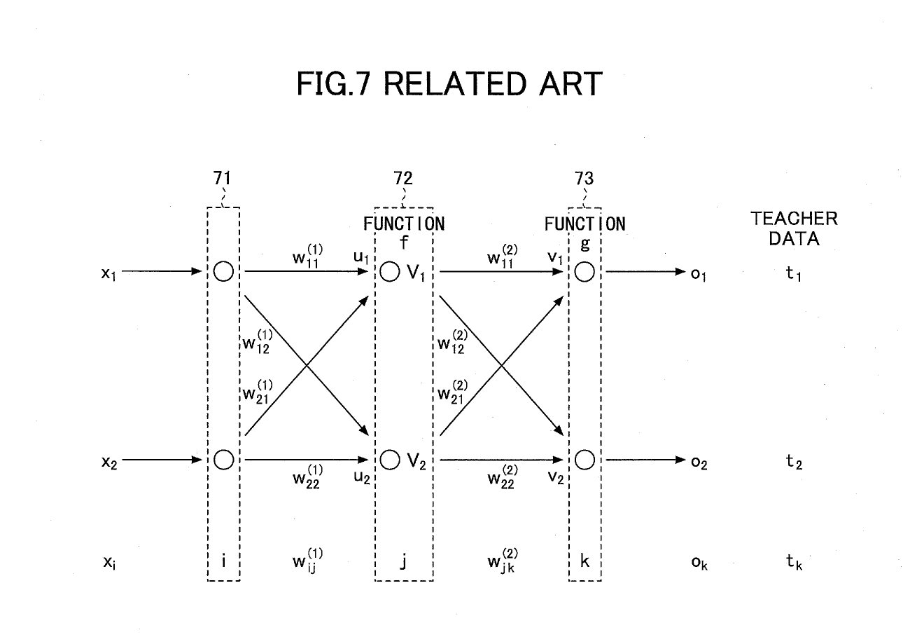

For convenience of description of backpropagation, a neural network formed of an input layer 71, a middle layer 72, and an output layer 73 as depicted in FIG. 7 is assumed. Furthermore, for convenience of description, it is assumed that the number of processing elements of each layer is two. The definition of symbols is as follows:

xᵢ: input data,
wᵢⱼ⁽¹⁾: a connection weight on the connection from the input layer 71 to the middle layer 72,
wⱼₖ⁽²⁾: a connection weight on the connection from the middle layer 72 to the output layer 73,
uⱼ: an input to the middle layer 72,
vₖ: an input to the output layer 73,
Vⱼ: an output from the middle layer 72,
f(uⱼ): the output function of the middle layer 72,
g(vₖ): the output function of the output layer 73,
oₖ: output data, and
tₖ: teacher data.

Letting a cost function E be the square error of output data and teacher data, Eq. (2) is obtained as follows:

$$E = \frac{1}{2} {\sum }_{k = 1}^{2} {( {t}_{k} - {o}_{k} )}^{2} \qquad ( 2 )$$

Here, consideration is given to determining optimum coefficients w by stochastic gradient descent (SGD) based on Eqs. (3) and (4). Then, the update equations of parameters are as expressed below in Eqs. (5) and (6):

$$\begin{matrix}{o}_{k} = g ( {v}_{k} ) & ( 3 ) \\ {o}_{k} = g ( {\sum }_{a = 1}^{2} {w}_{ak}^{( 2 )} {V}_{a} ) & ( 4 ) \\ {w}_{jk}^{{( 2 )}^{′}} = {w}_{jk}^{( 2 )} - α \frac{\partial E}{\partial {w}_{jk}^{( 2 )}} & ( 5 ) \\ {w}_{ij}^{{( 1 )}^{′}} = {w}_{ij}^{( 1 )} - α \frac{\partial E}{\partial {w}_{ij}^{( 1 )}} & ( 6 )\end{matrix}$$

The right side of Eq. (5) and the right side of Eq. (6) are the respective updated coefficients, and a is the learning rate.

First, the coefficient of the connection between the middle layer 72 and the output layer 73 is determined as expressed below in Eq. (7):

$$\begin{matrix}\frac{\partial E}{\partial {w}_{jk}^{( 2 )}} = \frac{\partial E}{\partial {o}_{k}} \frac{\partial {o}_{k}}{\partial {w}_{jk}^{( 2 )}} \\ = \frac{\partial }{\partial {o}_{k}} ( \frac{1}{2} {\sum }_{a = 1}^{2} {( {t}_{a} - {o}_{a} )}^{2} ) \frac{\partial }{\partial {w}_{jk}^{( 2 )}} g ( {\sum }_{a = 1}^{2} {w}_{ak}^{( 2 )} {V}_{a} ) \\ = - ( {t}_{k} - {o}_{k} ) {V}_{j} \frac{\partial g ( {v}_{k} )}{\partial {v}_{k}}\end{matrix} \qquad ( 7 )$$

Here, Eq. (7) turns into Eq. (9) based on Eq. (8) as follows:

$$\begin{matrix}{ɛ}_{k} = \frac{\partial E}{\partial {o}_{k}} = - ( {t}_{k} - {o}_{k} ) & ( 8 ) \\ \frac{\partial E}{\partial {w}_{jk}^{( 2 )}} = {ɛ}_{k} {V}_{j} \frac{\partial g ( {v}_{k} )}{\partial {v}_{k}} & ( 9 )\end{matrix}$$

where εₖ indicates an error signal at element k of the output layer 73.

Next, the coefficient of the connection between the input layer 71 and the middle layer 72 is determined as expressed below in Eq. (10):

$$\begin{matrix}\frac{\partial E}{\partial {w}_{ij}^{( 1 )}} = \frac{\partial E}{\partial {V}_{j}} \frac{\partial {V}_{j}}{\partial {w}_{ij}^{( 1 )}} \\ = {\sum }_{k = 1}^{2} ( \frac{\partial E}{\partial {o}_{k}} \frac{\partial {o}_{k}}{\partial {V}_{j}} ) \cdot \frac{\partial {V}_{j}}{\partial {w}_{ij}^{( 1 )}} \\ = {\sum }_{k = 1}^{2} ( {ɛ}_{k} \frac{\partial }{\partial {V}_{j}} g ( {\sum }_{a = 1}^{2} {w}_{ak}^{( 2 )} {V}_{a} ) ) \cdot \frac{\partial {V}_{j}}{\partial {w}_{ij}^{( 1 )}} \\ = {\sum }_{k = 1}^{2} ( {ɛ}_{k} {w}_{jk}^{( 2 )} \frac{\partial g ( {v}_{k} )}{\partial {v}_{k}} ) \cdot \frac{\partial {V}_{j}}{\partial {w}_{ij}^{( 1 )}} \\ = {\sum }_{k = 1}^{2} ( {ɛ}_{k} {w}_{jk}^{( 2 )} \frac{\partial g ( {v}_{k} )}{\partial {v}_{k}} ) \cdot \frac{\partial }{\partial {w}_{ij}^{( 1 )}} ( f ( {\sum }_{a = 1}^{2} {w}_{aj}^{( 1 )} {x}_{a} ) ) \\ = {\sum }_{k = 1}^{2} ( {ɛ}_{k} {w}_{jk}^{( 2 )} \frac{\partial g ( {v}_{k} )}{\partial {v}_{k}} ) \cdot {x}_{i} \frac{\partial f ( {u}_{i} )}{\partial {u}_{i}}\end{matrix} \qquad ( 10 )$$

Letting the error signal of element j of the middle layer 72 be defined by Eq. (11), the relationship is as expressed below in Eq. (12):

$$\begin{matrix}{ɛ}_{j} = {\sum }_{k = 1}^{2} ( {ɛ}_{k} {w}_{jk}^{( 2 )} \frac{\partial g ( {v}_{k} )}{\partial {v}_{k}} ) \cdot \frac{\partial f ( {u}_{i} )}{\partial {u}_{i}} & ( 11 ) \\ \frac{\partial E}{\partial {w}_{ij}^{( 1 )}} = {ɛ}_{j} {x}_{i} & ( 12 )\end{matrix}$$

Next, when generalized to the case where the number of elements of the middle layer 72 is K, Eq. (11) turns into Eq. (13) as follows:

$${ɛ}_{j} = {\sum }_{k = 1}^{K} ( {ɛ}_{k} {w}_{jk}^{( 2 )} \frac{\partial g ( {v}_{k} )}{\partial {v}_{k}} ) \cdot \frac{\partial f ( {u}_{i} )}{\partial {u}_{i}} \qquad ( 13 )$$

As a result, the update equations of the connection coefficients wᵢⱼ⁽¹⁾ and wⱼₖ⁽²⁾ are as expressed below in Eqs. (14) and (15), respectively, so that it is possible to determine the connection coefficients wᵢⱼ⁽¹⁾ and wⱼₖ⁽²⁾ from Eqs. (14) and (15) as follows:

$$\begin{matrix}{w}_{jk}^{{( 2 )}^{′}} = {w}_{jk}^{( 2 )} - {αɛ}_{k} {V}_{j} \frac{\partial g ( {v}_{k} )}{\partial {v}_{k}} \\ {ɛ}_{k} = \frac{\partial E}{\partial {o}_{k} = - ( {t}_{k} - {o}_{k} )} & ( 14 ) \\ {w}_{ij}^{{( 1 )}^{′}} = {w}_{ij}^{( 1 )} - {αɛ}_{j} {x}_{i} \\ {ɛ}_{j} = {\sum }_{k = 1}^{K} ( {ɛ}_{k} {w}_{jk}^{( 2 )} \frac{\partial g ( {v}_{k} )}{\partial {v}_{k}} ) \cdot \frac{\partial f ( {u}_{i} )}{\partial {u}_{i}} & ( 15 )\end{matrix}$$

In the case where the number of middle layers increases, the update equations are likewise expressed using the error signal ε of the preceding layer.

In the above-described calculations, one set of training data is used. Practically, however, multiple sets of training data are used. Letting the number of data sets be N, letting the nth data set be xᵢⁿ, and letting the error signals of the elements related to the nth data set be εₖⁿ and εⱼⁿ, the update equations in the case of performing optimization using gradient descent are as expressed below in Eqs. (16) and (17):

$$\begin{matrix}{w}_{jk}^{{( 2 )}^{′}} = {w}_{jk}^{( 2 )} - α {\sum }_{n}^{N} {ɛ}_{k}^{n} {V}_{j}^{n} \frac{\partial g ( {v}_{k}^{n} )}{\partial {v}_{k}^{n}} & ( 16 ) \\ {w}_{ij}^{{( 1 )}^{′}} = {w}_{ij}^{( 1 )} - α {\sum }_{n}^{N} {ɛ}_{j}^{n} {x}_{i}^{n} & ( 17 )\end{matrix}$$

If the value of the learning rate a is too large, the connection coefficients diverge. Therefore, it is desired to set the learning rate a to an appropriate value in accordance with input data and a network structure. When the learning rate a is set to a small value to prevent the divergence of the connection coefficients, it takes time in training (learning). Therefore, it is common practice to maximize the learning rate a to the extent that the connection coefficients do not diverge.

When described as the size of update at the time of training at step t, Eqs. (5) through (17) are expressed as Eq. (18) as follows:

$$Δ {w}_{ij}^{{( 1 )}^{′}} ( t ) = - α {\sum }_{n}^{N} {ɛ}_{j}^{n} {x}_{i}^{n} \qquad ( 18 )$$

Here, it is empirically known that training becomes faster when a momentum term is added so as to add the past direction to the convergence of coefficients. In this case, the update equation is as expressed in Eq. (19):

$$Δ {w}_{ij}^{{( 1 )}^{′}} ( t ) = ɛΔ {w}_{ij}^{{( 1 )}^{′}} ( t - 1 ) - α {\sum }_{n}^{N} {ɛ}_{j}^{n} {x}_{i}^{n} \qquad ( 19 )$$

The first term of the right side of Eq. (19) is the momentum term. In the momentum term, the portion expressed in (20) below is the size of update of the preceding step, and ε is a momentum coefficient. It is known that generally, the momentum is effective when e is approximately 0.9.

Δwᵢⱼ^{(1)′}(t−1) (20)

When all input data samples are evaluated in updating, it takes much time to perform a single parameter updating operation. Therefore, SGD may be used to solve the optimization problem in the training of neural networks. SGD is a simplified version of standard gradient descent, and is considered as a technique suitable for online learning. According to standard gradient descent, optimization is performed, using the sum of the cost functions of all data points as a final cost function. In contrast, according to SGD, one data point is randomly picked up, and parameters are updated with a gradient corresponding to the cost function of the data point. After updating, another data point is picked up to repeat the updating of the parameters.

As an optimization method in between standard gradient descent and SGD, there is a method that divides all data into multiple data groups referred to as “mini-batches” and optimizes parameters mini-batch by mini-batch. This method is often employed in the training of multilayer neural networks.

Next, the learning method according to this embodiment is described in comparison with a typical learning method known to the inventor.

According to the typical learning method (standard optimization method), a predetermined initial value of the learning rate is first set, and the learning rate is reduced as the updating of parameters progresses. Thus, the parameters are initially varied greatly to be close to solutions, and are thereafter finely corrected as the parameters become closer to the solutions.

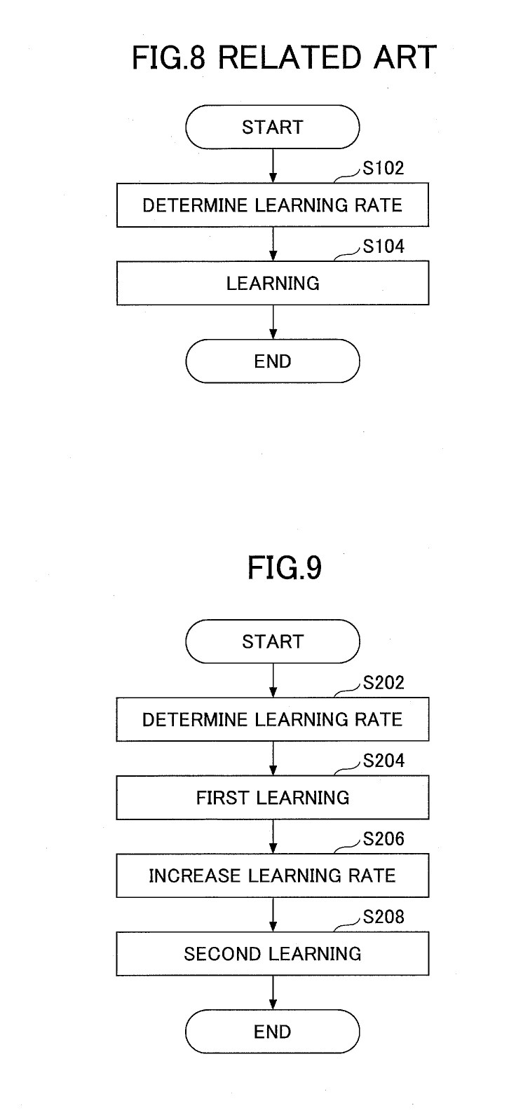

The typical learning method known to the inventor is specifically described with reference to FIG. 8.

First, at step S102, the initial value of the learning rate is determined. As described above, the initial value of the learning rate is set to a maximum value to the extent that a loss value (cost function value) does not diverge at an early stage. The loss value is an index value regarding the progress of learning, such as accuracy.

Next, at step S104, learning starts with the initial value of the learning rate. According to this learning, as the learning progresses, that is, as the updating of parameters progresses, the learning rate is reduced. For example, when the parameters are updated 100,000 times, the learning rate is reduced by one order of magnitude, and the learning is continued with the reduced learning rate. The learning ends when, for example, the number of times the parameters are updated reaches a predetermined value.

Next, the learning method according to this embodiment is described. According to the learning method of this embodiment, like in the typical learning method known to the inventor, the initial value of the learning rate is set to a maximum value to the extent that a loss value does not diverge at an early stage. The learning rate, however, is increased at least once after the updating of parameters progresses. As a result, while the loss value is prevented from diverging at an early stage, the size of change of parameters increases after the direction and appropriate initial values of parameters are determined for the first time after the start of learning. Accordingly, learning progresses fast. At this point, by using the above-described momentum term together, the direction of the updating of parameters is maintained. Accordingly, it is possible to further increase the learning speed. In this case, it is preferable that the continuity of the momentum coefficient be maintained even when the learning rate is increased during learning.

An increased value to which the learning rate is increased during learning is preferably greater than the initial value of the learning rate. Furthermore, the increased value is preferably a value that causes the loss value to diverge if set as the initial value of the learning rate.

Furthermore, instead of being increased at the time scheduled from the beginning, the learning rate may be automatically increased when it is determined that the loss value is reduced by a certain amount from the value at the start of learning.

The learning method according to this embodiment is specifically described with reference to FIG. 9.

First, at step S202, the initial value and the increased value of the learning rate are determined. As described above, the initial value of the learning rate is set to a maximum value to the extent that the loss value does not diverge at an early stage. The increased value, to which the learning rate is increased during learning, is set to a value greater than the preceding learning rate. Specifically, the increased value is set to a value greater than the last value of the learning rate in a first learning process (“first learning”) described below. The increased value may be further set to a value greater than the initial value of the learning rate, that is, a value that causes the loss value to diverge if set as the initial value. The first learning may be performed with the initial value of the learning rate being maintained or reduced as the first learning progresses.

Next, at step S204, the first learning is performed. The first learning starts with the initial value of the learning rate, and reduces the learning rate as the learning (training) progresses, that is, as the updating of parameters progresses. Alternatively, the first learning may be performed with the learning rate maintained at the initial value without being reduced. The first learning ends when, for example, the number of times the parameters are updated reaches a predetermined value or the loss value is reduced to a predetermined value.

Next, at step S206, the learning rate is increased. Specifically, the value of the learning rate is set to the increased value determined at step S202.

Next, at step S208, a second learning process (“second learning”) is performed. The second learning starts with the increased value of the learning rate, and reduces the learning rate as the learning (training) progresses, that is, as the updating of parameters progresses. The second learning may monotonously reduce the learning rate as the learning progresses. The second learning ends when, for example, the number of times the parameters are updated reaches a predetermined value or the loss value is reduced to a predetermined value.

In the second learning, the loss value is prevented from diverging even when the increased value of the learning rate is greater than the initial value. This is because learning has been performed to some extent in the first learning. Furthermore, the first learning and the second learning may be performed using the update equation of backpropagation, and the update equation of backpropagation may include a momentum term. Furthermore, according to this embodiment, during the transition from the first learning to the second learning, the learning rate is increased, but the continuity of the momentum term is maintained as described above.

By thus increasing the learning rate during learning, it is possible to reduce the loss value even with the same number of times the parameters are updated. In other words, it is possible to reduce the number of times the parameters are updated before the loss value reaches a predetermined value, and accordingly, to complete learning in a short time. That is, according to this embodiment, it is possible to increase the processing speed of a computer.

Next, the results of learning actually performed according to the above-described typical learning method known to the inventor and the learning method of this embodiment are described.

The results are of learning in a CNN of 22 layers with respect to the task of classifying input images into 1000 classes, using the image data of approximately 1.2 million images as training data. The network architecture is based on “model C” illustrated in He et al.

According to the typical learning method known to the inventor, the value of momentum is 0.9, the initial value of the learning rate is 0.001, which is a maximum value to the extent that the loss value does not diverge, and the learning rate is multiplied by 0.8 at every 10,000 times of updating (iterations). As a loss function for determining the loss value that indicates classification performance, the softmax function is employed.

According to the learning method of this embodiment, the value of momentum is 0.9, the initial value of the learning rate is 0.001, which is a maximum value to the extent that the loss value does not diverge, and the learning rate is multiplied by 0.8 at every 10,000 iterations. Furthermore, the learning rate is increased at 15,000 iterations during learning.

With respect to the learning method according to this embodiment, the size of the increased value of the learning rate and the divergence of the loss value with the progress of learning are studied. Specifically, the case of an increased value of 0.0016, which is twice the immediately preceding value (of the learning rate), the case of an increased value of 0.004, which is five times the immediately preceding value, the case of an increased value of 0.006, which is 7.5 times the immediately preceding value, the case of an increased value of 0.008, which is 10 times the immediately preceding value, the case of an increased value of 0.016, which is 20 times the immediately preceding value, the case of an increased value of 0.024, which is 30 times the immediately preceding value, and the case of an increased value of 0.032, which is 40 times the immediately preceding value are studied. According to the study, the loss value does not diverge when the increased value is 0.0016, which is twice the immediately preceding value, 0.004, which is five times the immediately preceding value, 0.006, which is 7.5 times the immediately preceding value, 0.008, which is 10 times the immediately preceding value, and 0.016, which is 20 times the immediately preceding value. On the other hand, the loss value diverges when the increased value is 0.024, which is 30 times the immediately preceding value, and 0.032, which is 40 times the immediately preceding value. Accordingly, according to the above-described learning method model, which is an example of the learning method according to this embodiment, it is possible to advance (continue) learning when the increased value, to which the learning rate is increased during learning, is less than or equal to 20 times the immediately preceding value of the learning rate.

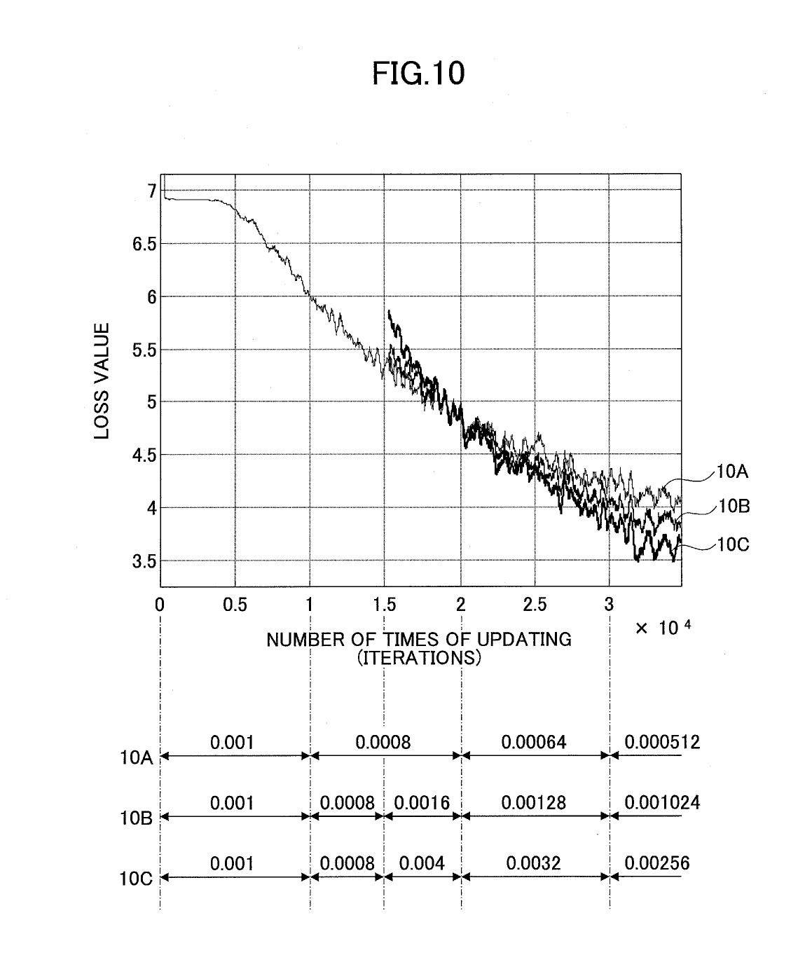

FIG. 10 illustrates the relationship between the number of times of updating and the loss value with respect to the typical learning method known to the inventor and the learning method according to this embodiment. Specifically, FIG. 10 illustrates the relationship in the case of the typical learning method known to the inventor (“learning method 10A”), the relationship in the case of a learning method 10B according to this embodiment where the increased value is 0.0016, which is twice the immediately preceding value of the learning rate, and the relationship in the case of a learning method 10C according to this embodiment where the increased value is 0.004, which is five times the immediately preceding value of the learning rate.

In the case of the learning method 10A, the learning rate starts with 0.001, and is reduced to be 0.8 times the immediately preceding value at every 10,000 iterations. That is, the learning rate starts with 0.001 and gradually decreases to 0.0008 at 10,000 iterations, to 0.00064 at 20,000 iterations, and to 0.000512 at 30,000 iterations.

In the case of the learning method 10B according to this embodiment, the learning rate starts with 0.001, and after being reduced to 0.0008 at 10,000 iterations, is increased to 0.0016, which is twice the immediately preceding value, at 15,000 iterations. Thereafter, the learning rate gradually decreases to 0.00128 at 20,000 iterations and to 0.001024 at 30,000 iterations.

In the case of the learning method 10C according to this embodiment, the learning rate starts with 0.001, and after being reduced to 0.0008 at 10,000 iterations, is increased to 0.004, which is five times the immediately preceding value, at 15,000 iterations. Thereafter, the learning rate gradually decreases to 0.0032 at 20,000 iterations and to 0.00256 at 30,000 iterations.

Thus, according to the learning methods 10B and 10C of this embodiment, the first learning switches to the second learning at 15,000 iterations.

As a result, the loss values of the learning methods 10A, 10B, and 10C are the same from the beginning up to immediately before 15,000 iterations. At 15,000 iterations, however, the loss values according to the learning methods 10B and 10C of this embodiment, in which the learning rate is increased, temporarily increase. At this point, the loss value according to the learning method 10C, by which the learning rate is increased to a value five times the immediately preceding value, is greater than the loss value according to the learning method 10B, by which the learning rate is increased to a value twice the immediately preceding value. Accordingly, at this point, the loss value of the learning method 10C is the largest, followed by the loss value of the learning method 10B and the loss value of the learning method 10A in this order.

Thereafter, as the learning progresses, the loss values of the learning methods 10A, 10B, and 10C decrease to be substantially equal at approximately 20,000 iterations. This is because when the learning rate is increased during learning, the learning thereafter progresses in a short time to increase the degree of reduction of the loss value. When the learning further progresses thereafter, the order of the loss values is reversed, so that the loss value of the learning method 10A becomes the largest, followed by the loss value of the learning method 10B and the loss value of the learning method 10C in this order. The differences in loss value become greater as the learning further progresses. As a result, between 32,000 iterations and 35,000 iterations, the loss value of the typical learning method 10A ranges from 4.0 to 4.2, the loss value of the learning method 10B of this embodiment ranges from 3.7 to 4.0, and the loss value of the learning method 10C of this embodiment ranges from 3.5 to 3.8. Thus, according to the learning method of this embodiment, compared with the typical learning method known to the inventor, it is possible to have a low loss value when learning with a predetermined number of times of updating is advanced, so that it is possible to completer learning in a short time.

According to the learning method of this embodiment, a larger multiplying factor by which the learning rate is multiplied to the increased value during learning may make it possible to complete learning in a shorter time. If the multiplying factor is too large, however, the loss value diverges. Therefore, it is inferred that learning is completed in the shortest time when the increased value, to which the learning rate is increased during learning, is set to a maximum value to the extent that the loss value does not diverge.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device.

The computer software can be provided to the programmable device using any storage or recording medium for storing processor readable code such as a floppy disk, a hard disk, a CD ROM, a magnetic tape device or a solid state memory device.

The hardware platform includes any desired hardware resources including, for example, a CPU, a RAM, and an HDD. The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

What is claimed is:

1. A learning method for a multilayer neural network, the learning method being implemented by a computer, the learning method comprising:
starting first learning with an initial value of a learning rate, and maintaining the learning rate at the initial value or reducing the learning rate from the initial value as the first learning progresses;
increasing the learning rate after the first learning; and
starting second learning with the increased learning rate, and reducing the increased learning rate as the second learning progresses.

2. The learning method according to claim 1, wherein the learning rate is increased to a value greater than the initial value in the increasing.

3. The learning method according to claim 1, wherein in the increasing, the learning rate is increased to such a value as to cause divergence of a loss value if the value is set as the initial value and the first learning starts with the value set as the initial value.

4. The learning method according to claim 1, wherein the first learning and the second learning are performed using an update equation of backpropagation including a momentum term.

5. The learning method according to claim 4, wherein the momentum term maintains continuity during a transition from the first learning to the second learning.

6. The learning method according to claim 1, wherein the first learning and the second learning are performed using an update equation of backpropagation.

7. The learning method according to claim 1, wherein the multilayer neural network is a convolutional neural network.

8. The learning method according to claim 1, wherein the multilayer neural network is a stacked autoencoder.

9. The learning method according to claim 1, wherein the multilayer neural network is a recurrent neural network.

10. The learning method according to claim 1, wherein the initial value of the learning rate does not cause divergence of a loss value.

11. The learning method according to claim 1, wherein the learning rate monotonously decreases as the second learning progresses.

12. The learning method according to claim 1, wherein the first learning and the second learning employ stochastic gradient descent.

13. A non-transitory recording medium having stored therein a program for causing a computer to execute a learning process for a multilayer neural network, the learning process comprising:
starting first learning with an initial value of a learning rate, and maintaining the learning rate at the initial value or reducing the learning rate from the initial value as the first learning progresses;
increasing the learning rate after the first learning; and
starting second learning with the increased learning rate, and reducing the increased learning rate as the second learning progresses.

14. A learning apparatus for a multilayer neural network, the learning apparatus comprising:
a processor; and
a memory storing a program that, when executed by the processor, causes the learning apparatus to:
start first learning with an initial value of a learning rate, and maintain the learning rate at the initial value or reduce the learning rate from the initial value as the first learning progresses;
increase the learning rate after the first learning; and
start second learning with the increased learning rate, and reduce the increased learning rate as the second learning progresses.
